(19) United States
(12) Patent Application Publication
(10) Pub. No.: US 2015/0008867 A1
(43) Pub. Date: Jan. 8, 2015

(54) CHARGE PUMP BATTERY CHARGING

(71) Applicant: AT&T Intellectual Property I, L.P., Atlanta, GA (US)

(72) Inventor: Boris Smychkovich, Alpharetta, GA (US)

(21) Appl. No.: 13/934,711

(22) Filed: Jul. 3, 2013

(51) Int. Cl. H02J 7/00

(52) U.S. Cl. CPC H02J 7/0052
USPC 320/107; 320/137

(57) ABSTRACT

Charge pump battery charging is disclosed. Charge pump battery charging can include accumulating charge on a charge storage device. The accumulated charge can be selectively discharged to facilitate recharging a battery. The discharge current can generally be at a higher average current than the charging current. The selective discharge can be based on a determined a discharge time, a determined duty cycle, or monitoring of the accumulated charge on the charge storage device. Control values related to the selective discharge can be updated from remotely located devices. Charge pump battery charging can provide for high current pulsed charging of NiMH battery cells at a low input current.

### TECHNICAL FIELD

The disclosed subject matter relates to recharging a battery cell.

### BACKGROUND

By way of brief background, conventional battery rechargers, such as those for nickel metal hydride (NIMH) batteries, can employ relatively high current values as compared to trickle chargers. As such, conventional battery rechargers are generally large and heavy components, such as wall transformer blocks, as compared to trickle charging devices that can employ smaller lighter plug in transformers due to lower current source requirements. The more substantial components of conventional high current chargers can be associated with numerous drawbacks, e.g., high cost of production, high cost of shipping, poor aesthetics, high operating cost, etc.

In some applications that employ battery backup systems, such as home security monitoring systems, the use of conventional battery rechargers can be undesirable, in part due to the aforementioned drawbacks. As such, some system operators resort to directly servicing battery backups rather than employing conventional rechargers. Direct servicing of batteries can include other drawbacks, such as a process for physically exchanging underperforming batteries by a service technician, having a service technician recharge a battery on site, etc.

### BRIEF DESCRIPTION OF DRAWINGS

FIG. 1 is an illustration of a system that facilitates charge pump battery charging in accordance with aspects of the subject disclosure.

FIG. 2 is a depiction of a system that facilitates capacitive charge pump battery charging in accordance with aspects of the subject disclosure.

FIG. 3 illustrates a system that facilitates charge pump battery charging with a non-linear component in accordance with aspects of the subject disclosure.

FIG. 4 illustrates a system that facilitates charge pump battery charging with an integrated circuit in accordance with aspects of the subject disclosure.

FIG. 5 illustrates exemplary systems that facilitate charge pump battery charging in accordance with aspects of the subject disclosure.

FIG. 6 illustrates a method facilitating charge storage for battery charging in accordance with aspects of the subject disclosure.

FIG. 7 illustrates a method facilitating charging a battery cell with a charge pump in accordance with aspects of the subject disclosure.

FIG. 8 illustrates a method facilitating enabling a charge transfer for battery charging based on NIMH battery condition and timing interval information in accordance with aspects of the subject disclosure.

FIG. 9 depicts a schematic block diagram of a computing environment with which the disclosed subject matter can interact.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Conventional battery chargers can include transformers sized to deliver a sufficient current to battery to cause recharging of the battery. For some battery chemistries, a higher current level than that associated with trickle charging, e.g., charging at low currents typically at or near the self-discharge rate of a battery under no load, can be required to achieve recharging in an efficacious manner. As such, even where a particular battery chemistry can be charged with a trickle charger, the health of the battery can often be better preserved with periodic charging at a higher rate of charge, e.g., at a higher current than that generally achieved with a trickle charger.

Higher current delivery, such as for periodic high current battery charging, can be achieved with conventional transformers. However, transformers sized to deliver higher currents are typically also larger, heavier, more expensive to produce, more expensive to ship, and bulkier than charge sources associated with lower charging currents generally associated with trickle charging techniques. Larger and more expensive transformers can be undesirable in products manufactured for consumers such as home security systems, etc. As such, manufacturers of consumer products can opt not to include high current chargers in consumer products that can keep batteries healthier than trickle chargers. Where a battery may only be occasionally used, such as a battery backup used in a failover system, e.g., battery backup s of home security products, battery backups for computers, etc., when a backup battery can be depleted in a failover event, such as a power failure, the battery can be replaced rather than recharged. Where the battery is replaced rather than recharged, additional costs can be associated with service calls to consumer locations to replace the battery. The drawbacks to conventional high current charging can be undesirable from a product design and service perspective. Further, the drawbacks of conventional high current charging can influence a consumer's desire to use a particular system employing a bulky high current source, or being subject to service calls when a battery is degraded.

Charge pump battery charging can provide high current battery charging with a low input current demand. Charge pump battery charging can employ smaller charge sources than conventional high current chargers. These smaller charge sources can include smaller transformers. Current is a measure of charge transfer over a time interval, e.g., one amp is defined as the transfer of one Coulomb of charge in one second. In an aspect of charge pump battery charging, a low level of charge can be transferred to a charge storage device over a first relatively long period of time resulting in a low current. This can accumulate charge on the charge storage device without the more significant currents generally associated with high current charging. The amassed charge can then be delivered to a battery over a second period of time that is less than the first period of time. This more rapid charge delivery to the battery can be associated with a higher current. Charge storage devices can include capacitors. A capacitor can generally be charged slowly and discharged rapidly. As such, a low input current can be used to charge a capacitor that can then be rapidly discharged at a higher current to a battery to cause at least a portion of a recharging event.

In an aspect, a charge pump battery charger can therefore employ a smaller transformer, or other charge source, to provide charge collection on a charge storage device that can then be discharged comparatively rapidly to charge a battery at a higher current than the input current. As such, a charging current can be at an amperage below a threshold amperage while a discharge current used to recharge a battery can be above the threshold amperage. Further, where charging/discharging currents change as a function of the voltage at a charge storage device such as a capacitor, the charging current amperage can generally be understood to be below the threshold amperage during the charging of the charge storage device. Similarly, when discharging the charge storage device to recharge the battery, the discharge amperage can be understood to begin at a current greater than the threshold amperage even though at long time constants the discharge current can drop to amperages below the threshold amperage. As such, charging current is contemplated to encompass at least non-linear current during charging a capacitor or other charge storage device, but excluding transient current events, such as those that can occur during switching events, due to coupled noise, etc. Further, discharging current is contemplated to encompass at least non-linear current during discharging a capacitor or other charge storage device. In an example embodiment, a 2700 μF capacitor can be charged for 1 second at about 100 mA through a 120 Ohm resistor, though the charging current drops off rapidly as the capacitor charges up. The charge accumulated on the capacitor can then be discharged to a battery under charge in about 50 msec. By discharging over a shorter time and through a corresponding lower resistance, such as 10 Ohms, a higher current of about one amp can be achieved, although this current also drops off rapidly as the capacitor charge is depleted. However, the charging current can still be considered below a threshold value, e.g., 100 mA can be less than an example 150 mA threshold, and the discharge current can still be considered above the threshold current, e.g., 1 A can be greater than the example 150 Ma threshold even though after several time constants the discharge current can actually drop below the threshold value as the capacitor is drained. Where the battery under charge in this example is a 1.5V nickel metal hydride (NIMH) battery, cycling the charging and discharging can achieve recharging of the depleted battery in about 37 hours. This 37 hour recharge period can be less than the recharge period prescribed by organizations such as Underwrites Laboratories (UL) that indicates recharging should occur in less than 48 hours.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages and novel features of the disclosed subject matter will become apparent from the following detailed description when considered in conjunction with the provided drawings.

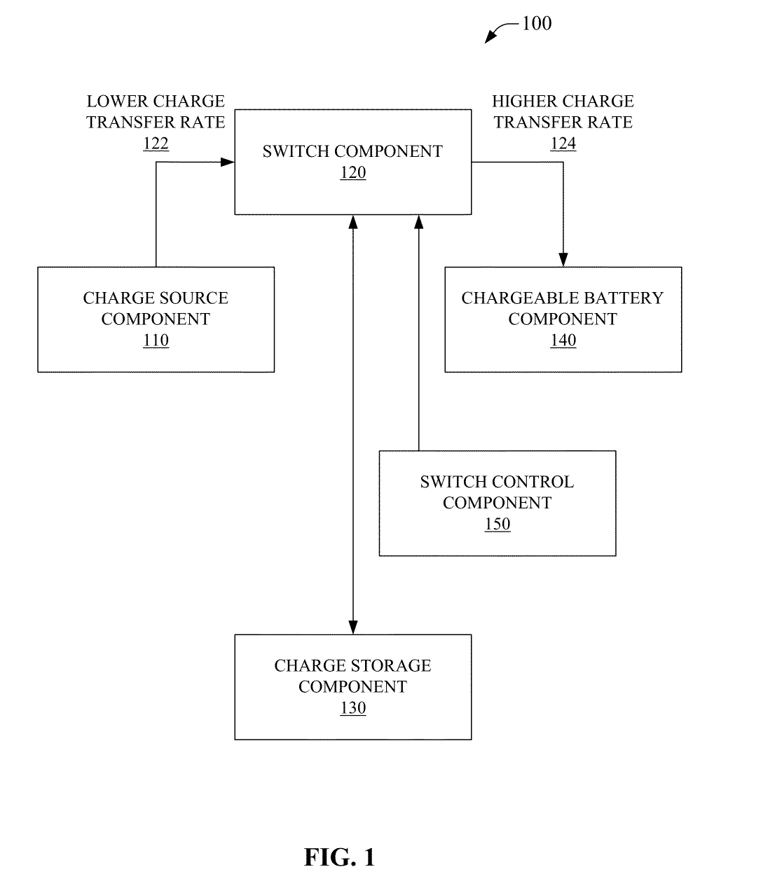

FIG. 1 is an illustration of a system 100, which facilitates charge pump battery charging in accordance with aspects of the subject disclosure. System 100 can include charge source component 110. Charge source component 110 can be a transformer, rectifier, etc. In an embodiment, charge source component 110 can be a 12 VDC consumer transformer that can be plugged into a residential wall outlet. These types of consumer transformers are common and are available with a wide array of performance characteristics. Charge source component 110 can source charge at a rate sufficient to allow charging of a charge storage component to at least a predetermined level in a designated period of time, e.g., 100 mA, etc. In an aspect, charge source component 110 can source current to switch component 120 at lower charge transfer rate 122.

Switch component 120 can receive charge from charge source component 110 at lower charge transfer rate 122. Switch component 120 can direct the received charge to charge storage component 130 based on switch control information. In an embodiment, switch control information can control a switch device of switch component 120 to connect and/or disconnect an electrically conductive path between charge source component 110 and charge storage component 130. Switch component 120 can therefore include electrical relays, transistors, or switching integrated circuits (ICs), etc. Further, switch component 120 can, in various embodiments, comprise one or more single-pole-single-throw switches, one or more dual-pole-single-throw switches, etc., which switches can comprise one or more relays, transistors, discrete components, etc. As an example, switch component 120 can comprise a dual-pole-single-throw switch of a normally-closed-normally-open configuration such that a conductive path charges charge storage component 130 in a first throw position and then discharges charge storage component 130 in a second throw position. Of note, in some embodiments of system 100, a permanent conductive path between charge source component 110 and charge storage component 130 can be employed. In these embodiments, the path through switch component 120 between charge source component 110 and charge storage component 130 can simply be treated as a permanently closed switch, e.g., a switch that is not toggled to an open state.

In a further aspect, switch component 120 can provide for a switched conductive pathway between charge storage component 130 and chargeable battery component 140. As such, charge stored on charge storage component 130 can be discharged to chargeable battery component 140 at higher charge transfer rate 124 based on the switch state between charge storage component 130 and chargeable battery component 140. The discharge of charge storage component 130 to chargeable battery component 140 can transfer charge to chargeable battery component as part of recharging a battery.

Switch component 120 can receive switch control information by way of switch control component 150. Switch control component 150 can therefore affect the connection state between charge source component 110 and charge storage component 130. Furthermore, switch control component 150 can affect the connection state between charge storage component 130 and chargeable battery component 140. Switch control information can include digital or analog control signals. These signals can control relays, transistors, ICs, etc., comprising switch component 120.

Switch control information can be based on rules relating to electrical characteristics of system 100, such as information related to an amount of charge stored at charge storage component 130, rates of charge transfer to charge storage component 130, rates of discharge of charge storage component 130, temperatures, power failures, failover states, battery health, battery charge level, voltages, currents, or nearly any other electrical characteristic. As an example, switch component 120 can monitor a voltage level of charge storage component 130. When charge storage component 130 reaches a predetermined voltage level designated by switch control component 150, switch component 120 can close a switch between charge storage component 130 and chargeable battery component 140. This can cause discharge of the stored charge to a battery. The discharge current can similarly be monitored by switch component 120, such that when the discharge current drops below a predetermined current level switch component 120 can open the switch between charge storage component 130 and chargeable battery component 140. As such, charge source component 110 can deliver charge to charge source component 130 until charge source component 130 reaches a particular voltage that can trigger discharge of charge storage component 130 to recharge a battery while the discharge current is above a predetermined level. When the discharge current drops below that predetermined level the discharge is ended and charge storage component 130 can begin amassing charge again until it reaches the predetermined voltage level and the cycle repeats.

Switch control information can also be based on rules relating to timing, duty cycle, etc., such as predetermined charge/discharge periods, charge/discharge duty cycles, etc. As an example, for a given charging resistance between charge source component 110 and charge storage component 130, and for a given charge storage capacitance of charge storage component 130, a time constant can be determined, e.g., an RC value. This can reflect the exponential charging and discharging behavior of a capacitor used as a charge storage device, e.g.,

$$v ( t ) = 1 - {e}^{- \frac{1}{T} t} .$$

As such, a charging time can be designated as 3RC, e.g., three time constants, to charge the capacitor to about 95%. In this example, where R is 120 Ohm and C is 2700 μF, 3RC is about 1 second. This designated charging time information can therefore be employed by switch component 120 to allow a conductive path between charge source component 110 and charge storage component 130 for one second. Similarly, as an example of the discharge side of system 100 having 10 Ohms of resistance between charge storage component 130 and chargeable battery component 140 for the same 2700 μF capacitance of charge storage component 130, the discharge time can be set to 2RC allowing discharge of approximately 85% of stored charge to the battery in about 55 msec. This designated discharge time information can therefore be employed by switch component 120 to allow a conductive path between charge storage component 130 and chargeable battery component 140 for 0.055 seconds. In this example, charge can be amassed at charge storage component 130 at about 100 mA for 1 second and then discharged at about 1 A for 0.055 seconds.

Charging and discharging of charge storage component 130 can be dependent on electrical characteristics of the components selected for system 100. In an example embodiment, charge source component 110 can be a voltage source and charge storage component 130 can be a capacitive storage element. The conductive path between charge source component 110 and charge storage component 130 can include a resistor, or equivalent element. Thus, the charging behavior can be generally governed by the current flowing through the resistive element. In another example embodiment, the resistive element can be replaces with an inductive element to govern current flow into the storage capacitor. In a further example embodiment, a non-linear device, such as a transistor, can act as the charge source and can govern the charging characteristics of the charge storage component 130. These and other permutations of circuit design are to be considered within the scope of the present disclosure although they will not be discussed at length herein for the sake of clarity and brevity.

In an aspect, switch component 120 can receive other control signals and/or information related to controlling the switching behavior of switch component 120. These other control signals can include enable signals, over-temperature signals, damaged battery information, environmental information such as humidity, ground faults, ambient temperature, etc., external control signals such as timing information updates, battery maintenance information, planned battery discharge information, etc. These and other control signals and/or information are to be considered within the scope of the subject disclosure although further disclosure herein can be limited for clarity and brevity. As an example, a server can send a control signal to switch component 120 causing it to hold open the conductive path between charge storage component 120 and chargeable battery component 140 while the battery of chargeable battery component 140 is intentionally drained in anticipation of an upcoming service call, e.g., a signal can be received from a remote source to prevent recharging of the battery allowing the battery to be drained (by another system outside the scope of the instant disclosure) so that the battery is in a drained state when a service technician arrives to service a device comprising system 100. This can allow a service department to remotely and preemptively drain a battery so that when a service technician arrives the battery is already discharged.

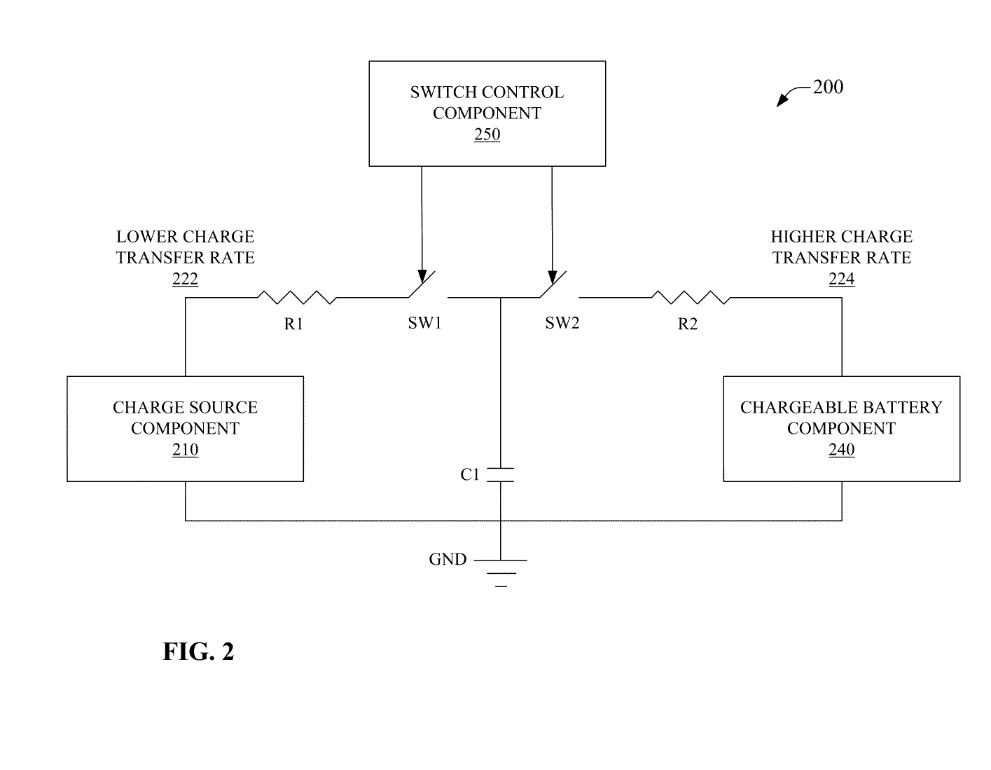

FIG. 2 is a depiction of a system 200 that can facilitate capacitive charge pump battery charging in accordance with aspects of the subject disclosure. System 200 can include charge source component 210. Charge source component 210 can be a transformer, rectifier, etc. In an embodiment, charge source component 210 can be a 12 VDC consumer transformer that can be plugged into a residential wall outlet. Charge source component 210 can source charge at a rate sufficient to allow charging of capacitor C1 to at least a predetermined level in a designated period of time, e.g., 100 mA current, etc. In an aspect, charge source component 210 can source current through resistor R1 and switch SW1 at lower charge transfer rate 222.

Switch SW1 can receive charge from charge source component 210 at lower charge transfer rate 222. Switch SW1 can direct the received charge to capacitor C1 based on switch control information. In an embodiment, switch control information can control a switch SW1 to connect and/or disconnect an electrically conductive path between charge source component 210 and capacitor C1. Switch SW1 can therefore include electrical relays, transistors, switching integrated circuits (ICs), etc. Of note, in some embodiments of system 200, a permanent conductive path between charge source component 210 and capacitor C1 can be employed, e.g., switch SW1 can be replaced with a conductor.

In a further aspect, switch SW2 can provide for a switched conductive pathway between capacitor C1 and chargeable battery component 240, e.g., through resistor R2. As such, charge stored on capacitor C1 can be discharged to chargeable battery component 240 at higher charge transfer rate 224 based on the switch state of switch SW2 between capacitor C1 and chargeable battery component 240. The discharge of capacitor C1 to chargeable battery component 240 can transfer charge to chargeable battery component as part of recharging a battery.

Switch control component 250 can affect the connection state between charge source component 210 and capacitor C1, e.g., by way of switch SW1. Furthermore, switch control component 250 can affect the connection state between capacitor C1 and chargeable battery component 240, e.g., by way of switch SW2. Switch control information can include digital or analog control signals. These signals can control relays, transistors, ICs, etc., comprising switch SW1 or SW2.

Switch control information can be based on rules relating to electrical characteristics of system 200, such as information related to an amount of charge stored at capacitor C1, rates of charge transfer to capacitor C1, rates of discharge of capacitor C1, temperatures, power failures, failover states, battery health, battery charge level, voltages, currents, or nearly any other electrical characteristic. As an example, switch control component 250 can monitor a voltage level of capacitor C1. When capacitor C1 reaches a predetermined voltage level designated by switch control component 250, switch SW2 can close between capacitor C1 and chargeable battery component 240. This can cause discharge of the stored charge to a battery. The discharge current can similarly be monitored by switch control component 250, such that when the discharge current drops below a predetermined current level switch SW2 can open between capacitor C1 and chargeable battery component 240. As such, charge source component 210 can deliver charge to capacitor C1 until it reaches a particular voltage that can trigger discharge of capacitor C1 to recharge a battery while the discharge current is above a predetermined level. When the discharge current drops below that predetermined level, the discharge is ended and capacitor C1 can begin amassing charge again until it reaches the predetermined voltage level and the cycle repeats.

Switch control information can also be based on rules relating to timing, duty cycle, etc., such as predetermined charge/discharge periods, charge/discharge duty cycles, etc. As an example, for a given charging resistance, e.g., resistor R1, between charge source component 210 and capacitor C1, and for a given capacitance of capacitor C1, a time constant can be determined. As such, a charging time can be designated, such as three RC time constants, to charge the capacitor to about 95%. In this example, where R is 120 Ohm and C is 2700 μF, the designated charging time can be about 1 second. This designated charging time information can therefore be employed to control switch SW1 and allow a conductive path between charge sourced component 210 and capacitor C1 for 1 second. Similarly, in an example discharge of capacitor C1 where resistor R2 is 10 Ohms and for the same 2700 μF capacitance of capacitor C1, the discharge time can be designated as two time constants, e.g., allowing discharge of approximately 85% of stored charge to the battery, which can be about 55 msec. This designated discharge time information can therefore be employed to control switch SW2 to allow a conductive path between capacitor C1 and chargeable battery component 240 for 0.055 seconds. In these examples, charge can be amassed at capacitor C1 at about 100 mA for 1 second and then discharged at about 1 A for 0.055 seconds.

Charging and discharging of capacitor C1 can be dependent on electrical characteristics of the components selected for system 200. The conductive path between charge source component 210 and capacitor C1 can include a resistor, such as resistor R1, or an equivalent element. Thus, at a constant voltage, the charging behavior can be generally governed by the current flowing through resistor R1. In another example embodiment, the resistive element can be replaced with an inductive element to govern current flow into capacitor C1. In a further example embodiment, a non-linear device, such as a transistor, can act as the charge source and can govern the charging characteristics of capacitor C1. These and other permutations of circuit design are within the scope of the present disclosure although they are not discussed at length herein for the sake of clarity and brevity.

In an aspect, switch control component 250 can receive other control signals and/or information related to controlling the switching behavior of switch SW1 and/or SW2. These other control signals can include enable signals, over-temperature signals, damaged battery information, environmental information such as humidity, ground faults, ambient temperature, etc., external control signals such as timing information updates, battery maintenance information, planned battery discharge information, etc. These and other control signals and/or information are to be considered within the scope of the subject disclosure although further disclosure herein can be limited for clarity and brevity.

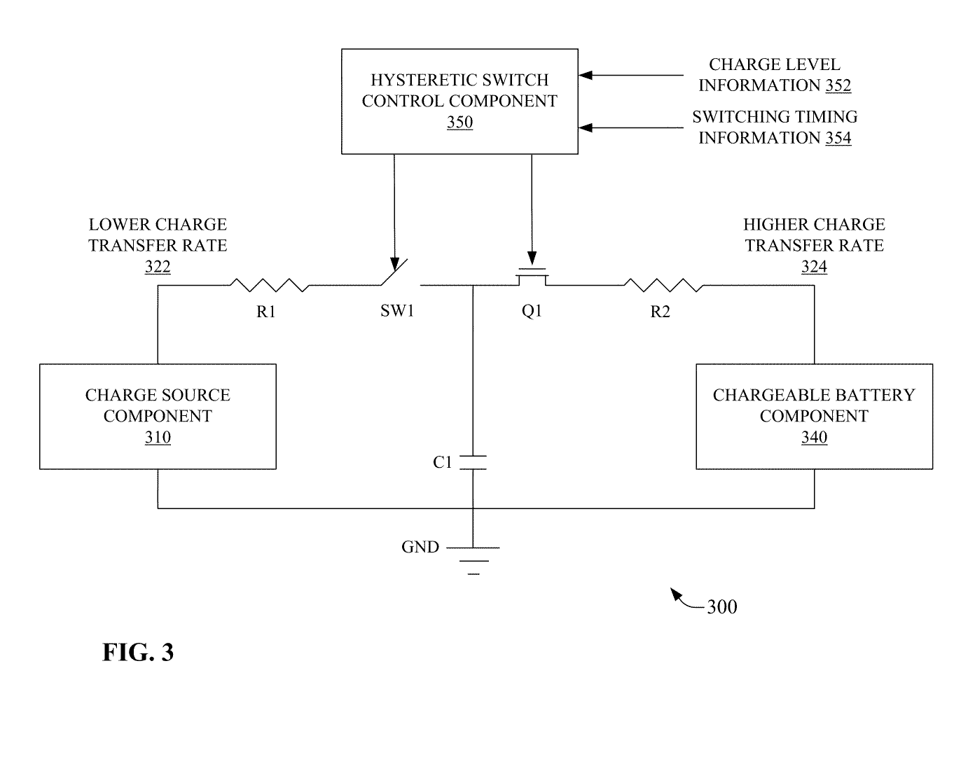

FIG. 3 illustrates a system 300 that facilitates charge pump battery charging with a non-linear component in accordance with aspects of the subject disclosure. System 300 can include charge source component 310. Charge source component 310 can be a transformer, rectifier, etc. In an embodiment, charge source component 310 can be a 12 VDC consumer transformer that can be plugged into a residential wall outlet. Charge source component 310 can source charge at a rate sufficient to allow charging of capacitor C1 to a predetermined level in a designated period of time, e.g., 100 mA current, etc. In an aspect, charge source component 310 can source current through resistor R1 and switch SW1 at lower charge transfer rate 322.

Switch SW1 can receive charge from charge source component 310 at lower charge transfer rate 322. Switch SW1 can direct the received charge to capacitor C1 based on switch control information. In an embodiment, switch control information can control a switch SW1 to connect and/or disconnect an electrically conductive path between charge source component 310 and capacitor C1. Switch SW1 can include electrical relays, transistors, switching integrated circuits (ICs), etc. Of note, in some embodiments of system 300, a permanent conductive path between charge source component 310 and capacitor C1 can be employed, e.g., switch SW1 can be replaced with a conductor.

In a further aspect, switch transistor Q1 can provide for a controlled conductive pathway between capacitor C1 and chargeable battery component 340, e.g., through resistor R2. As such, charge stored on capacitor C1 can be discharged to chargeable battery component 340 at higher charge transfer rate 324 based on the state of transistor Q1 between capacitor C1 and chargeable battery component 340. The discharge of capacitor C1 to chargeable battery component 340 can transfer charge to chargeable battery component as part of recharging a battery.

Hysteretic switch control component 350 can affect the connection state between charge source component 310 and capacitor C1, e.g., by way of switch SW1. Furthermore, hysteretic switch control component 350 can affect the connection state between capacitor C1 and chargeable battery component 340, e.g., by way of transistor Q2. The connection state can be controlled based on switch control information that can include digital or analog control signals. These signals can control relays, transistors, ICs, etc., comprising switch SW1 or transistor Q2. Switch control information can include charge level information 352 and/or switching timing information 354.

Switch control information can be based on rules relating to electrical characteristics of system 300, such as information related to an amount of charge stored at capacitor C1, rates of charge transfer to capacitor C1, rates of discharge of capacitor C1, temperatures, power failures, failover states, battery health, battery charge level, e.g., charge level information 352, voltages, currents, or nearly any other electrical characteristic. As an example, switch control component 350 can receive charge level information 352 relating to the charge condition of a battery cell included in chargeable battery component 340. When a condition related to charge level information 352 is satisfied, switching of switch SW1 and transistor Q1 can be effected to cause charging of the battery to occur. As an example, when the battery drops to 70% charge, this information can cause hysteretic switch control component 350 to facilitate recharging of the battery.

Switch control information can also be based on rules relating to timing, e.g., switching timing information 354, duty cycle, etc., such as predetermined charge/discharge periods, charge/discharge duty cycles, etc. As an example, timing information can indicate a charge period of 1 second and a discharge period of 0.055 seconds. This timing information can be based on values of components employed in system 300, measured values for charge transfer associated with capacitor C1, etc.

Hysteretic switch control component 350 can facilitate employing hysteresis in switching behaviors. Hysteresis can embody switching dependence system 300 not only on its current environment, but also on its past environment. As an example, transistor Q1 can be turned on when a condition related to charge on capacitor C1 is satisfied, for example, the charge on capacitor C1 has reached a threshold level. Further, transistor Q1 can be turned off when both the condition related to charge on capacitor C1 is not satisfied and a condition related to current through R2 is also not satisfied.

Charging and discharging of capacitor C1 can be dependent on electrical characteristics of the components selected for system 300. The conductive path between charge source component 310 and capacitor C1 can include a resistor, such as resistor R1, or an equivalent element. Thus, at a constant voltage, the charging behavior can be generally governed by the current flowing through resistor R1. In another example embodiment, a resistive element, e.g., inductor R2, can govern current flow out of capacitor C1. In a further example embodiment, a non-linear element, e.g., transistor Q1, can govern current flow out of capacitor C1. These and other permutations of circuit design are within the scope of the present disclosure although they are not further discussed at length herein for the sake of clarity and brevity.

In an aspect, switch control component 350 can receive other control signals and/or information related to controlling the switching behavior of switch SW1 and/or transistor Q1. These other control signals can include enable signals, over-temperature signals, damaged battery information, environmental information such as humidity, ground faults, ambient temperature, etc., external control signals such as timing information updates, battery maintenance information, planned battery discharge information, etc. These and other control signals and/or information are to be considered within the scope of the subject disclosure although further disclosure herein can be limited for clarity and brevity.

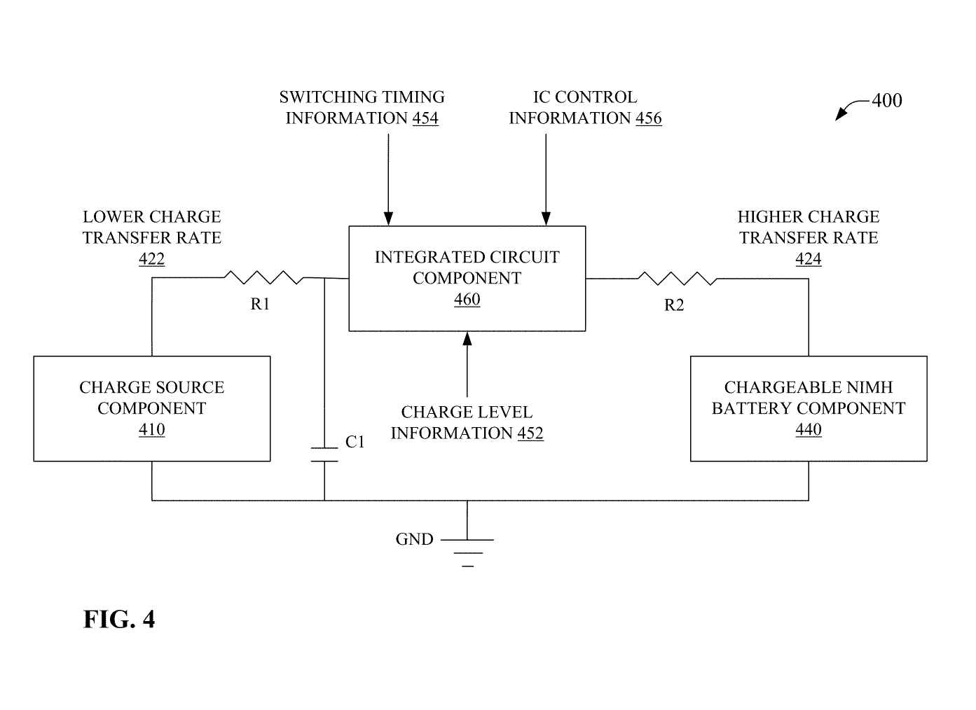

FIG. 4 illustrates a system 400 that facilitates charge pump battery charging with an integrated circuit in accordance with aspects of the subject disclosure. System 400 can include charge source component 410. Charge source component 410 can be a transformer, rectifier, etc. In an embodiment, charge source component 410 can be a 12 VDC consumer transformer that can be plugged into a residential wall outlet. Charge source component 410 can source charge at a rate sufficient to allow charging of capacitor C1 to at least a predetermined level in a designated period of time, e.g., 100 mA current, etc. In an aspect, charge source component 410 can source current through resistor R1 to capacitor C1 at lower charge transfer rate 422.

Integrated circuit component 460 can receive charge from charge source component 410 at lower charge transfer rate 422 and from capacitor C1. Integrated circuit component 460 can direct the received charge to chargeable NIMH battery component 440 based on switch control information. In an embodiment, switch control information can control a switch to connect and/or disconnect an electrically conductive path between capacitor C1 and a NIMH battery of chargeable NIMH battery component 440. Integrated circuit component 460 can therefore include transistors or other types of switching integrated circuits (ICs). Integrated circuit component 460 can provide for a switched conductive pathway between capacitor C1 and chargeable NIMH battery component 440, e.g., through resistor R2. As such, charge stored on capacitor C1 can be discharged to chargeable NIMH battery component 440 at higher charge transfer rate 424 based on a switch state. Switch control information can include digital or analog control signals.

Switch control information can be based on rules relating to electrical characteristics of system 400, such as information related to an amount of charge stored at capacitor C1, rates of charge transfer to capacitor C1, rates of discharge of capacitor C1, temperatures, power failures, failover states, battery health, battery charge level, voltages, currents, or nearly any other electrical characteristic. Switch control information can also be based on rules relating to timing, duty cycle, etc., such as predetermined charge/discharge periods, charge/discharge duty cycles, etc. Switch control information can also be based on IC control information 456. IC control information 456 can include enable/disable signals, power save feature signaling, sleep timer signaling, etc. As an example, where integrated circuit component 460 includes TEXAS INSTRUMENTS TPS54232, IC control information can active the TPS54232 ECO-MODE feature of the IC by dragging down the COMPONENT pin voltage to prevent discharge through the high side integrated MOSFET.

Charging and/or discharging of capacitor C1 can be dependent on electrical characteristics of the components selected for system 400. The conductive path between charge source component 410 and capacitor C1 can include a resistor, such as resistor R1, or an equivalent element. Thus, at a constant voltage, the charging behavior can be generally governed by the current flowing through resistor R1. These and other permutations of circuit design are within the scope of the present disclosure although they are not discussed at length herein for the sake of clarity and brevity.

In an aspect, integrated circuit component 460 can receive other control signals and/or information related to controlling the switching behavior. These other control signals can include enable signals, over-temperature signals, damaged battery information, environmental information such as humidity, ground faults, ambient temperature, etc., external control signals such as timing information updates, battery maintenance information, planned battery discharge information, etc. These and other control signals and/or information are to be considered within the scope of the subject disclosure although further disclosure herein can be limited for clarity and brevity.

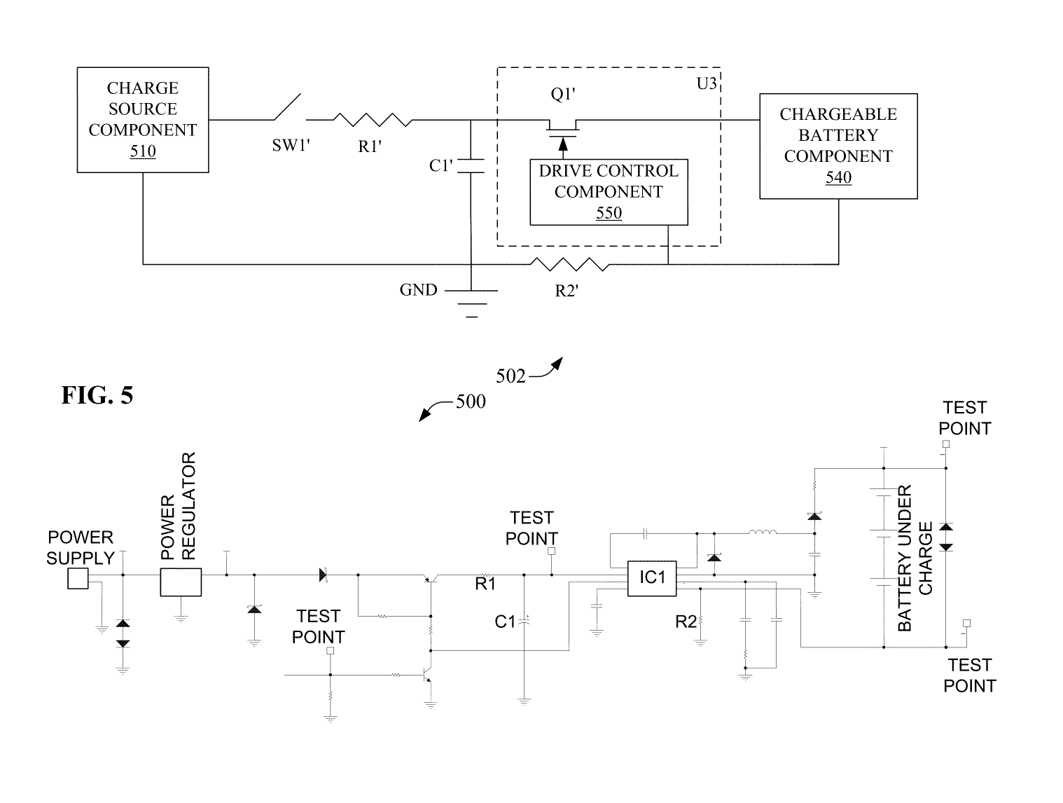

FIG. 5 illustrates exemplary systems 500 and 502 that facilitate charge pump battery charging in accordance with aspects of the subject disclosure. System 500 can be a non-limiting example circuit for charge pump battery charging. System 500 can include power supply and power regulator to source charge to C1 through R1 as illustrated. Charge accumulated on capacitor C1 can be passed to battery cells comprising battery under charge by way of integrated circuit IC1. In an example embodiment, power supply and power regulator of system 500 can correspond to charge source component 501 of system 502.

In one possible embodiment, IC1 of system 500 can be a TEXAS INSTRUMENTS TPS54232 device or similar device. IC1 can control the discharge of C1 to battery under charge. In an aspect, control of the charge transfer from C1 to battery under charge can be based on electrical parameters, e.g., voltage, current, etc., at R2. As an example, current can flow from C1 to battery under charge through IC1 and then to ground through R2, such that, for example, the voltage across R2 can be employed to control the current flow through IC1. In an embodiment, IC1 of system 500 can correspond to U3 of system 502. Similarly, R1, C1, and R2 of system 500 can correspond respectively to R1′, C1′, and R2′ of system 502. Likewise, in an embodiment, battery under charge of system 500 can correspond to chargeable battery component 540 of system 502.

System 502 can include charge source component 510. Charge source component 510 can be a transformer, rectifier, etc. In an embodiment, charge source component 510 can be a 12 VDC consumer transformer that can be plugged into a residential wall outlet. Charge source component 510 can source charge at a rate sufficient to allow charging of capacitor C1′ to a predetermined level in a designated period of time, e.g., with 100 mA current, etc. In an aspect, charge source component 510 can source current through resistor R1′ and switch SW1′.

Switch SW1′ can receive charge from charge source component 510. Switch SW1′ can direct the received charge to capacitor C1′ based on the switch state of SW1′. In an embodiment, switch control information (not illustrated) can control a switch, e.g., SWF1′, to connect and/or disconnect an electrically conductive path between charge source component 510 and capacitor C1′. Switch SW1′ can comprise electrical relays, transistors, switching integrated circuits (ICs), etc. Of note, in some embodiments of system 500, a permanent conductive path between charge source component 510 and capacitor C1′ can be employed, e.g., switch SW1′ can be replaced with a conductor.

In a further aspect, transistor Q1′ can provide for a controlled conductive pathway between capacitor C1′ and chargeable battery component 540. As such, charge stored on capacitor C1′ can be discharged to chargeable battery component 540 based on the state of transistor Q1′ between capacitor C1′ and chargeable battery component 540. The discharge of capacitor C1′ to chargeable battery component 540 can transfer charge to chargeable battery component as part of recharging a battery.

Drive control component 550 can affect the connection state between capacitor C1′ and chargeable battery component 540, e.g., by way of transistor Q1′. The connection state can be controlled based on drive control information (not illustrated) that can include digital or analog control signals. In an embodiment, drive control information can be based on the voltage between chargeable battery component 540 and resistor R2′.

Drive control information can be based on rules relating to electrical characteristics of system 502, such as information related to an amount of charge stored at capacitor C1′, rates of charge transfer to capacitor C1′, rates of discharge of capacitor C1′, temperatures, power failures, failover states, battery health, battery charge level, voltages, currents, or nearly any other electrical characteristic. As an example, drive control component 550 can receive voltage level information 552 relating to the current being driven through a battery cell included in chargeable battery component 540. When a condition related to the example current is satisfied, transistor Q1′ can be driven to cause controlled current from C1′ through Q1′ to effect charging of the battery. As an example, when current through chargeable battery component 540 drops below a threshold level, Q1′ can be driven to allow more charge to pass from C1′ to chargeable battery component 540, e.g., drive control component 550 can adjust the current passing from C1′ to the battery under charge. In another example embodiment, when current through chargeable battery component 540 drops below another threshold level, Q1′ can be driven to allow no charge to pass from C1′ to chargeable battery component 540, e.g., when charging current drops off, Q1′ can be “opened” to allow charge to accumulate on C1′ assuming SW1′ is correspondingly in a “closed” position.

Drive control information can also be based on rules relating to timing, duty cycle, etc., such as predetermined charge/discharge periods, charge/discharge duty cycles, etc. As an example, timing information can indicate a charge period of 1 second and a discharge period of 0.055 seconds. This timing information can be based on values of components employed in system 502, measured values for charge transfer associated with capacitor C1′, etc. In an embodiment Q1′ and drive control component 550 can be comprised in an IC, e.g., U3.

Charging and discharging of capacitor C1′ can be dependent on electrical characteristics of the components selected for system 502. The conductive path between charge source component 510 and capacitor C1′ can include a resistor, such as resistor R1′, or an equivalent element. Thus, at a constant voltage, the charging behavior of C1′ can be generally governed by the current flowing through resistor R1′. In another example embodiment, a non-linear element, e.g., transistor Q1′, can govern current flow out of capacitor C1′. These and other permutations of circuit design are within the scope of the present disclosure although they are not further discussed at length herein for the sake of clarity and brevity.

In an aspect, drive control component 550 can receive other control signals and/or information related to controlling the behavior of transistor Q1′. These other control signals can include enable signals, over-temperature signals, damaged battery information, environmental information such as humidity, ground faults, ambient temperature, etc., external control signals such as timing information updates, battery maintenance information, planned battery discharge information, etc. These and other control signals and/or information are to be considered within the scope of the subject disclosure although further disclosure herein can be limited for clarity and brevity.

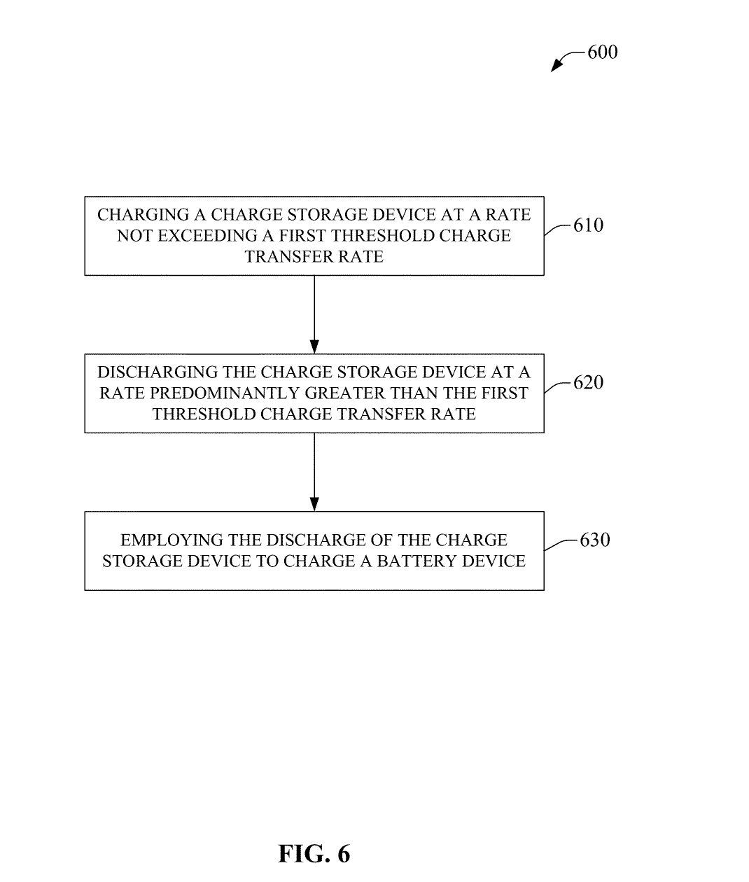

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 illustrates aspects of method 600 facilitating charge storage for battery charging in accordance with aspects of the subject disclosure. At 610, method 600 can include charging a charge storage device at a rate not exceeding a first threshold charging rate. In an aspect, the first threshold charging rate can be related to charge provided by a current source, a voltage source across a resistor, etc. As an example, a 12 VDC transformer can provide about 100 mA across a 120 ohm resistor and, as such can be under a first threshold charging rate determined to be 150 mA. This current can accumulate charge on the charge storage device at a lower charge transfer rate than that associated with conventional high current charging methods. In an embodiment, the charge storage device can comprise a capacitor. In an aspect, the charge transfer rate can fluctuate over time, for example, as a charge storage capacitor builds up charge with increasing time connected to a charging source, the voltage drop across a preceding series resistor can drop resulting in a lower current through the series resistor as a function of charging time. In another aspect, the charging rate can be subject to less fluctuation, such as where a constant current source provides charge to a charge storage capacitor at a relatively constant current until the capacitor reaches a steady state, e.g., a functional open circuit, at which point more charge cannot be pushed onto the capacitor.

At 620, method 600 can include discharging the charge storage device at a rate predominantly greater than the first threshold charge transfer rate. Where charge has accumulated on a charge storage device, this charge can be discharged more quickly that it was accumulated. As an example, where the charge storage device is a 2700 μF capacitor charged for 1 second at a current not exceeding about 100 mA, the same capacitor can be discharged in about 0.055 seconds at a rate of about 1 A.

At 630, method 600 can include employing the discharge of the charge storage device to charge a battery device. At this point method 600 can end. Where the discharge rate is at a comparatively higher charge transfer rate than the charge rate, a plurality of charge discharge cycles can be needed to recharge a depleted battery. As an example, recharging a 1.5 AH NIMH battery with about a 1 A and 0.055 second discharge cycle associated with about a 100 mA and 1.0 second charge cycle, can take about 37 hours, e.g., about 126,000 charge/discharge cycles.

In an embodiment, a switching device can be employed to control the conductive connection between a charge storage device and a charge source, e.g., in the charging cycle at 610. In a further embodiment, another switching device can be employed to control the conductive connection between a charge storage device and a battery under charge, e.g., the discharging cycle at 620. These switch devices can include relays, transistors, ICs, etc. Switching can be based on digital or analog control signals.

Switch control information can be based on rules relating to electrical characteristics a device employing method 600, such as information related to an amount of charge stored at the charge storage device, rates of charge transfer to the charge storage device, rates of discharge of the charge storage device, temperatures, power failures, failover states, battery health, battery charge level, voltages, currents, or nearly any other electrical characteristic. As an example, switching can be based monitoring a voltage level of the charge storage device. When the charge storage device reaches a predetermined voltage level, method 600 can, for example, move to block 620 from block 610. This can cause discharge of the stored charge to a battery, e.g., at 630. The discharge current can similarly be monitored, such that when the discharge current drops below a predetermined current level method 600 can be, for example, repeated from block 610. As such, a charge source can deliver charge to the charge storage device (e.g., 610) until it reaches a particular voltage which can trigger discharge (e.g., 620) of the charge storage device to recharge a battery (e.g., 630) while the discharge current is above a predetermined level. When the discharge current drops below that predetermined level the discharge can be ended and the charge storage device can begin amassing charge again (e.g., return to 610) until it reaches the predetermined voltage level and the cycle repeats. Switch control information can also be based on rules relating to timing, duty cycle, etc., such as predetermined charge/discharge periods, charge/discharge duty cycles, etc. As an example, charge can be amassed at the charge storage device (e.g., 610) at about 100 mA for 1 second and then discharged (e.g., 620 and 630) at about 1 A for 0.055 seconds.

Charging and discharging of a charge storage device can be dependent on electrical characteristics of the components selected for a device employing method 600. A conductive path between a charge source and charge storage device can include a resistor, such as resistor R1 of system 200, or an equivalent element. Thus, at a constant voltage, the charging behavior can be generally governed by the current flowing through resistor R1. In another example embodiment, the resistive element can be replaced with an inductive element to govern current flow into the charge storage device. In a further example embodiment, a non-linear device, such as a transistor, can act as the charge source and can govern the charging characteristics of capacitor C1. These and other permutations of circuit design are within the scope of the present disclosure although they are not discussed at length elsewhere herein for the sake of clarity and brevity.

In another aspect, switch control signals and/or information related to controlling the switching behavior of switching devices employed in deploying a device using method 600, can include enable signals, over-temperature signals, damaged battery information, environmental information such as humidity, ground faults, ambient temperature, etc., external control signals such as timing information updates, battery maintenance information, planned battery discharge information, etc. These and other control signals and/or information are to be considered within the immediate scope of the subject disclosure, however further disclosure herein is limited for clarity and brevity.

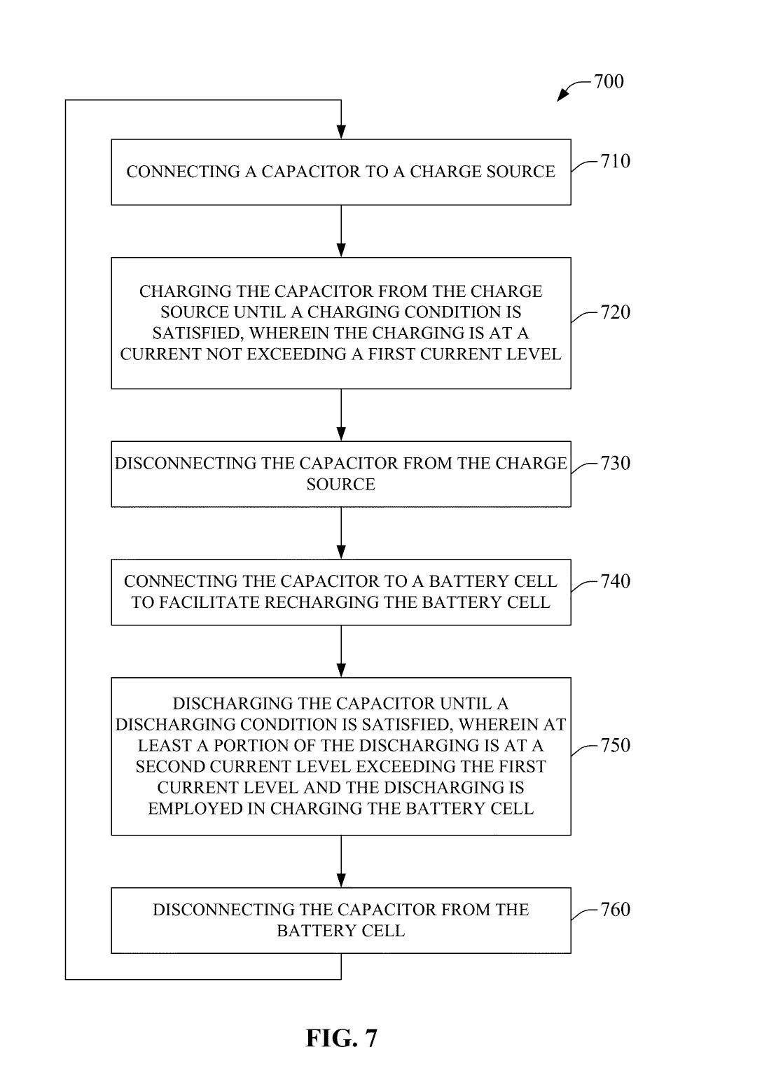

FIG. 7 illustrates a method 700 that facilitates charging a battery cell with a charge pump in accordance with aspects of the subject disclosure. At 710, method 700 can include connecting a capacitor to a charge source. At 720, the capacitor can be charged from the charge source until a charging condition is satisfied. The charging at 720 can be at a current not exceeding a first current level. In an aspect, the first charging level can be related to charge provided by a current source, a voltage source across a resistor, etc. As an example, a 12 VDC transformer can provide about 100 mA across a 120 ohm resistor and, as such can be under a first charging level determined to be 150 mA. This current can accumulate charge on the capacitor at a lower charge transfer rate than that associated with conventional high current charging methods.

At 730, the capacitor can be disconnected from the charge source. At 740, the capacitor can be connected to a battery cell to facilitate recharging the battery cell. At 750, method 700 can include discharging the capacitor until a discharging condition is satisfied. At least a portion of the discharging is at a second current level exceeding the first current level. Further, the discharging can be employed in charging the battery cell.

At 760, method 700 can include disconnecting the capacitor from the battery cell. At this point, method 700 can end. Alternatively, method 700 can return to block 710 to begin another iteration of the charge/discharge cycle.

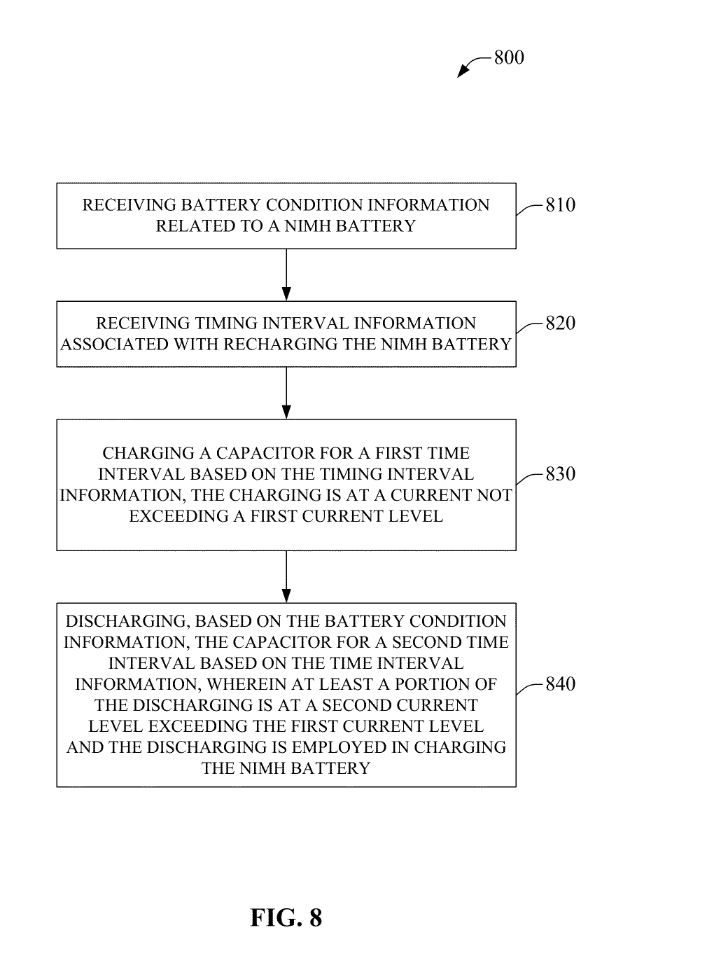

FIG. 8 illustrates a method 800 that facilitates enabling a charge transfer for battery charging based on NIMH battery condition and timing interval information in accordance with aspects of the subject disclosure. At 810, method 800 can include receiving battery condition information related to a NIMH battery. Battery condition information can include electrical characteristic information or physical characteristic information. As an example, battery condition information can reflect the present level of battery charge, e.g., that the NIMH battery is at 85% of full charge. As another example, battery condition information can indicate the temperature of the battery, e.g., that the NIMH battery is over-temperature, at normal operating temperature, etc.

At 820, the method can include receiving timing interval information associated with recharging the NIMH battery. Timing interval information can be related to determined timing periods, duty cycle, etc. As such, timing interval information can reflect predetermined charge/discharge periods, charge/discharge duty cycles, etc. As an example, timing interval information can define a charging period of 1 second and a discharge period of 55 msec. As another example, timing interval information can indicate that charging should have a 100% duty cycle and discharging should have a 5% duty cycle, e.g., a charge storage device is constantly receiving charge from a charge source and is cyclically discharged for 5% of a cycle. Where the discharge is at a greater rate than the charging rate, this will deplete the charge storage device that will then charge up again in the 95% of the cycle in which the charge storage device is not in the discharge condition.

At 830, method 800 can include, charging a capacitor for a first time interval based on the timing interval information. The charging is at a current not exceeding a first current level. In an aspect, the first current level can be related to charge provided by a current source, a voltage source across a resistor, etc. As an example, a 12 VDC transformer can provide about 100 mA across a 120 ohm resistor and, as such can be under a first current level, for example, determined to be 150 mA.

At 840, method 800 can include discharging the capacitor for a second time interval based on the battery condition information and based on the time interval information. At least a portion of the discharging is at a second current level exceeding the first current level. Further, the discharging can be employed in charging a NIMH battery. At this point, method 800 can end.

In an embodiment, timing interval information can be received from a device located distant from the device employing method 800. As an example, timing interval information can be received from a central server device. Communication can be by wired or wireless communications services, including macro cellular service, femtocell services, Wi-Fi, Ethernet, intranet, or internet services. As such, for devices such as security monitoring systems, including those that have wireless communications capabilities such as cellular radios, timing interval information can be pushed out to devices in the field from a provider's server and can facilitate remote updating of operating parameters for recharging NIMH batteries, such as backup power batteries. Further, rules and conditions relating to battery condition information can also be pushed out in a similar manner. This can allow a service provider to adjust the recharging parameters and conditions from a centralized update server and can aid in keeping operating devices employing method 800 up to date. In a still further aspect, some timing interval information or battery condition information received from a remote server, or other remote controller device, can be employed to accomplish tasks at designated devices employing method 800. As an example the charging and discharging duty cycles can be set to 0%, or zero seconds, to prevent recharging of a battery. As such, in conjunction with other service features from a remote location, a battery can be directed to be discharged by a designated time so that a service technician can arrive and service a device with a preemptively discharged battery, etc.

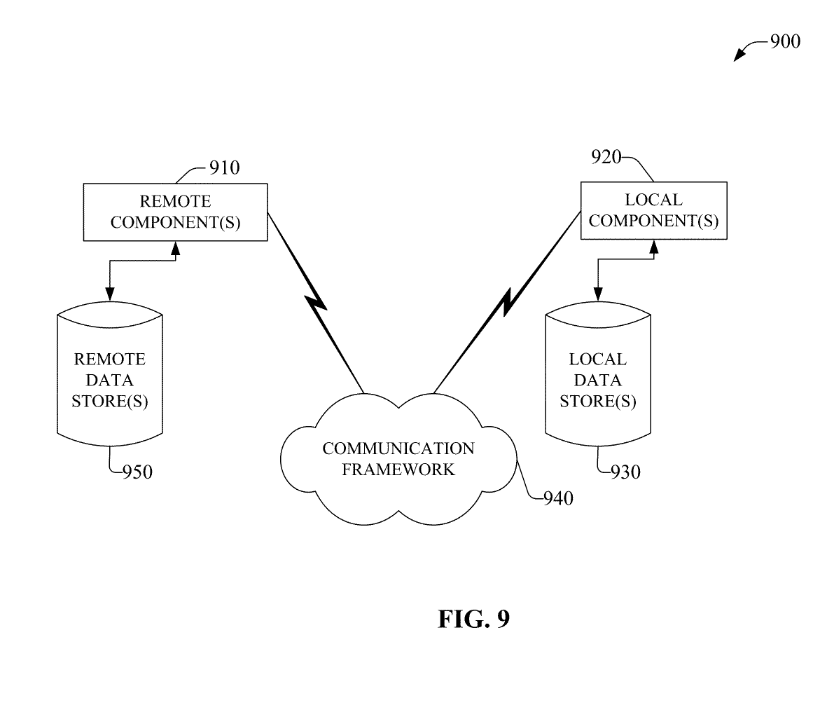

FIG. 9 is a schematic block diagram of a computing environment 900 with which the disclosed subject matter can interact. The system 900 includes one or more remote component(s) 910, which can include client-side component(s). The remote component(s) 910 can be hardware and/or software (e.g., threads, processes, computing devices). In some embodiments, remote component(s) 910 can include mobile devices, such as smartphones, tablet computers, laptop computers, etc. As an example, remote component(s) 910 can be client-side components, such as switch control component 150, 250, etc., hysteretic switch control component 350, integrated circuit component 460, etc., embodied in a client side system. A client side system can be, for example, a home security monitoring device, a battery backup device for a client computer, a mobile device charging station with battery backup, etc.

The system 900 also includes one or more local component(s) 920, which can include server-side component(s). The local component(s) 920 can be hardware and/or software (e.g., threads, processes, computing devices). In some embodiments, local component(s) 920 can include server devices, base stations such as NodeBs, eNodeBs, etc., access points, etc. As an example, local component(s) 920 can be a network carrier server device, e.g., server device of a wireless telecommunications provider.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. As an example, services information, focus state information, device environment information, proximity determination information, location information, etc., can be communicated over a packet-switched or circuit-switched channels between a mobile device, e.g., remote component 910, and a server device, e.g., a local component 920, over an air interface, such as on a packet-switched or circuit-switched downlink channel. The system 900 includes a communication framework 940 that can be employed to facilitate communications between the remote component(s) 910 and the local component(s) 920, and can include an air interface, e.g., Uu interface of a UMTS network. Remote component(s) 910 can be operably connected to one or more remote data store(s) 950, such as PNS data store 430, 432, 434, etc., that can be employed to store information, such as push-notification state information, on the remote component(s) 910 side of communication framework 940. Similarly, local component(s) 920 can be operably connected to one or more local data store(s) 930, such as PNS data store 437, etc., that can be employed to store information, such as push-notification state information, on the to the local component(s) 920 side of communication framework 940.

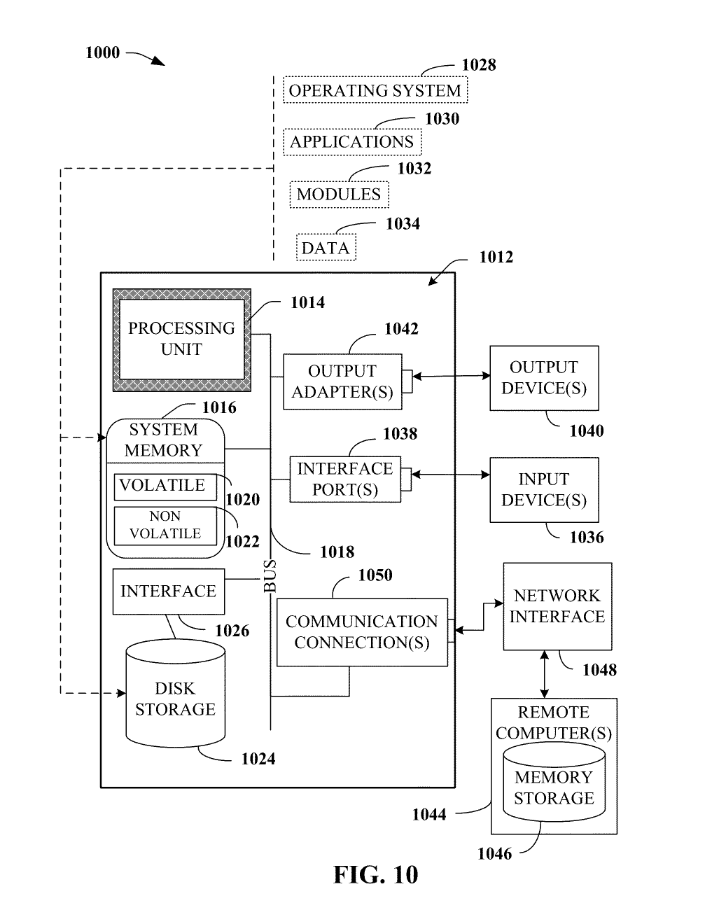

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can include random access memory, which acts as external cache memory. By way of illustration and not limitation, random access memory is available in many forms such as synchronous random access memory , dynamic random access memory, synchronous dynamic random access memory, double data rate synchronous dynamic random access memory, enhanced synchronous dynamic random access memory, Synchlink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, including single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of switch control component 150, 250, etc., hysteretic switch control component 350, integrated circuit component 460, etc., or part of a computer control system for a device comprising system 100, 200, 300, 400, 500, etc., or employing method 600, 700, or 800, etc., includes a processing unit 1014, a system memory 1016, and a system bus 1018. System bus 1018 couples system components including, but not limited to, system memory 1016 to processing unit 1014. For example, a security monitoring system can comprise computer 1012 and system 100 to provide failover power protection and recharging of the failover battery supporting the security monitoring system. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can include volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can include read only memory, programmable read only memory, electrically programmable read only memory, electrically erasable read only memory, or flash memory. Volatile memory 1020 includes read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, Synchlink dynamic read only memory, Rambus direct read only memory, direct Rambus dynamic read only memory, and Rambus dynamic read only memory.

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, a user interface can be embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies include fiber distributed data interface, copper distributed data interface, Ethernet, Token Ring and the like. Wide area network technologies include, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and digital subscriber line modems, integrated services digital network adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B,” “home access point,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio access network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include broadcast technologies (e.g., sub-Hertz, extremely low frequency, very low frequency, low frequency, medium frequency, high frequency, very high frequency, ultra-high frequency, super-high frequency, terahertz broadcasts, etc.); Ethernet; X.25; powerline-type networking, e.g., Powerline audio video Ethernet, etc; femto-cell technology; Wi-Fi; worldwide interoperability for microwave access; enhanced general packet radio service; third generation partnership project, long term evolution; third generation partnership project universal mobile telecommunications system; third generation partnership project 2, ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a charge storage device that accumulates charge from a current below a first current level;
a discharge device that selectively discharges a discharge current from the charge storage device, wherein at least a portion of the discharge current is at a second current level greater than the first current level; and
a battery that receives the discharge current to facilitate recharging the battery.

2. The system of claim 1, wherein the battery is a nickel metal hydride battery.

3. The system of claim 1, wherein the charge storage device is a capacitive charge storage device.

4. The system of claim 1, wherein the discharge device selectively discharges the charge storage device based on temporal control of the discharge device to facilitate conductively coupling the charge storage device to the battery.

5. The system of claim 4, wherein the switching device comprises a non-linear electronic device.

6. The system of claim 5, wherein the non-linear electronic device comprises a transistor.

7. The system of claim 5, wherein the non-linear electronic device is comprised in an integrated circuit.

8. The system of claim 4, wherein temporal control comprises a discharge time period that is adaptable.

9. The system of claim 1, wherein the discharge device selectively discharges the charge storage device based on the charge accumulated by the charge storage device to facilitate a conductive coupling of the charge storage device to the battery.

10. The system of claim 1, wherein the discharge device selectively discharges the charge storage device based on a control value, and the control value is received from a network device of a wireless network remotely located from the discharge device.

11. A method, comprising:
accumulating charge on a charge storage device at a current below a first determined current level; and
selectively activating a discharge device to facilitate conductively coupling the charge storage device to a battery for a discharge period to facilitate recharging the battery, wherein conductively coupling the charge storage device to the battery results in discharging the charge storage device at a current that is greater that the first determined current level for at least a portion of the discharge period.

12. The method of claim 11, wherein the charge storage device is a capacitor.

13. The method of claim 11, wherein the battery is a nickel metal hydride battery.

14. The method of claim 11, wherein the discharge device is included in an integrated circuit.

15. The method of claim 10, wherein the selectively activating the discharge device is based on a determined time.

16. The method of claim 15, wherein the determined time is received from a remotely located server device.

17. A computer-readable storage medium having instructions stored thereon that, in response to execution, cause a device comprising a processor to perform operations, the operations comprising:
accumulating charge on a capacitor at an amperage below a first defined amperage current; and
selectively activating a switch to facilitate conductively coupling the capacitor to a battery for a discharge period to facilitate recharging the battery, wherein, in response to the capacitor being conductively coupled to the battery, the capacitor discharges at another amperage that is greater than the first defined amperage for at least a portion of the discharge period.

18. The computer-readable storage medium of claim 17, wherein the selectively activating the switch facilitates the capacitor being conductively coupled to a nickel metal hydride battery.

19. The computer-readable storage medium of claim 17, wherein the switch is a transistor of an integrated circuit.

20. The computer-readable storage medium of claim 17, wherein the selectively activating the switch is based on a condition related to the charge accumulated on the capacitor being determined to be satisfied and a parameter related to the condition being determined to have been received from a remotely located storage device.
